(19) United States
(12) Patent Application Publication
(10) Pub. No.: US 2007/0284310 A1
(43) Pub. Date: Dec. 13, 2007

(54) Method and system for purifying ethanol

(76) Inventors: Johannes van Leeuwen, Ames, IA (US); Rick Wood, Cedar Rapids, IA (US); Jacek A. Koziel, Ames, IA (US)

Correspondence Address: JOHANNES VAN LEEUWEN, 203 HICKORY DRIVE, AMES, IA, 50014, US

(21) Appl. No.: 11/450,238

(22) Filed: Jun. 12, 2006

(51) Int. Cl. C02F 1/28; C02F 1/78

(52) U.S. Cl. 210/694; 210/760

(57) ABSTRACT

A method and system for treating a distilled ethanol or alcoholic spirit wherein the spirit is contacted with ozone and granular activated carbon in sequence to provide an ozonated distilled spirit product of improved purity, aroma, taste or character.

### BACKGROUND OF THE INVENTION

This application is a continuation-in-part application of copending U.S. application on METHOD AND SYSTEM FOR TREATING A DISTILLED SPIRIT by Wood, van Leeuwen and Koziel, submitted Apr. 21, 2006, (number used by attorney: Mell0001).

The invention relates to treating various ethanol-containing distillates produced in the production of fuel ethanol to make a higher quality product and to a system to carry out the treatment. More particularly, the invention relates to a method and system for treating fuel grade ethanol to produce beverage and pharmaceutical grades alcohol.

Fuel ethanol and beverage alcohol, which is also ethanol, are both made by enzyme and yeast fermentation of starches in milled corn and separated by subsequent distillation. Certain fermentation components are carried over with the ethanol during distillation as organic impurities. Such impurities will probably not have much effect on the ethanol quality as a fuel, but make the ethanol undesirable in pharmaceutical applications and/or beverage alcohol. These impurities would impart an undesirable aftertaste or bitter flavor to a distilled spirit that may be consumed in pharmaceuticals or when imbibed as an alcoholic beverage. Some of these components cause malodors and some may even be toxic if concentrations are high.

Higher quality alcohol for human consumption is produced with more care than fuel grade ethanol. Different approaches to achieve this may be through selection of higher quality feed stocks, selected yeasts and/or additional purification of the final product, usually by additional stages of distillation. Controlling or removing undesirable odor and taste components can be important to maintain or improve the quality of a distilled alcoholic beverage and hence the demand for this product. The required additional measures make the production of beverage and pharmaceutical grade alcohol more expensive than simple fuel grade ethanol. additional measures make the production of beverage and pharmaceutical grade alcohol more expensive than simple fuel grade ethanol.

A simpler and more economical process that could remove impurities from a lower grade ethanol, such as fuel grade ethanol, would be desirable as a possible alternative route or means of producing beverage and pharmaceutical grade ethanol.

### BRIEF DESCRIPTION OF THE INVENTION

The invention relates to the quality improvement of ethanol produced by fermentation and distillation, particularly purification and quality enhancement by ozonation.

In a first embodiment, the invention is a method for purifying fuel grade ethanol, or an intermediate distillate in fuel grade ethanol production, or industrial alcohol production, comprising contacting the ethanol or alcohol product with ozone and activated carbon and recovering an ozonated alcohol product of higher quality and fewer and lower concentrations of undesirable organic products originating from fermentation.

In another embodiment, the invention is a method of processing ethanol, comprising continuously charging a condensed distilled fermentation product to the top of a processing column to flow downwardly through the column; supplying an ozone mixture with oxygen or air to the bottom of the processing column to flow counter-currently against and to intimately contact the downwardly flowing product to produce an ozonated product from the ethanol; charging the ozonated product from the processing column to the top of an adsorption column; and flowing the ozonated product downwardly through the adsorption column to recover an improved ethanol product at the bottom of the adsorption column.

In another embodiment, the invention is a system for processing ethanol, comprising: an ozone generator; and a contact tower with a continuous ozone containing gas mixture feed from an ozone generator at the bottom, a liquid ethanol feed at the top of the column and a recovery port to collect an ozonated ethanol product. The product is treated further by providing for a few minutes' contact time with granular activated carbon.

### BRIEF DESCRIPTION OF THE DRAWINGS

FIG. 1 is a schematic representation of the system to produce an upgraded distillation product from the yeast fermentation of various substrates to produce ethanol;

FIG. 2 is a chromatogram for 95% ethanol from a dry corn milling ethanol plant;

FIG. 3 is a headspace chromatogram for ethanol samples with and without ozone and granular activated carbon treatment;

FIG. 4 is a bar graph comparison of ethanol quality and headspace odor after different treatments

### DETAILED DESCRIPTION OF THE INVENTION

In this application, a distilled spirit is ethanol or ethyl alcohol prepared for use as a gasoline supplement by distillation of the broth or beer from the fermentation of corn or some other plant material such as starch, sugar or molasses.

Substances other than ethanol are produced during fermentation, such as higher alcohols, organic acids, esters, aldehydes, tannins and the like. Some of these substances are volatile. Most of the volatile substances have no effect on ethanol quality as a fuel. Some volatile substances in alcohol for beverage or medicinal purposes are undesirable.

Water and volatile substances are evaporated and then condensed with the ethanol in various amounts during distillation. The amounts, i.e. variety and concentrations, of such impurities in fuel grade ethanol are greater than in a grain neutral spirit, which is what is used in beverage or pharmaceutical grade alcohol.

The invention provides a method to adjust the quality of a distilled product or intermediate product from a fuel ethanol production plant.

To produce ethanol, a grain (frequently corn) or other biomass fermentation product is subjected to distillation, by which most of the ethanol is vaporized and condensed in a separate vessel. Along with the ethanol, other low boiling organic compounds and at least 4% water, are vaporized and condensed. These volatiles add specific distinctive qualities to the distillate, depending on the raw materials used in the original brew.

Ethanol can be made from seed grains, particularly corn, by a dry mill process or a wet mill process. Most of the ethanol in the U.S. is made using the dry corn milling method. In the dry mill process, the starch portion of the corn is converted into sugar by cooking and by adding enzymes, the sugars fermented with yeasts and the ethanol is removed by distillation. The wet milling process separates various components in the corn seeds first and then uses the separated starch to make ethanol in a similar process to the dry milling as described.

The majority of the ethanol in the U.S. is made from corn, but it can also be produced from other feedstocks such as grain sorghum, wheat, barley, potatoes, and even grass or wood chips. Brazil, the world's largest ethanol producer, makes the fuel from sugarcane.

The dry milling process first involves milling, liquefaction, saccharification and fermentation.
Milling The feedstock passes through a hammer mill to make meal.
Liquefaction The meal is mixed with water and alpha-amylase, then passed through cookers where the starch is liquefied. Heat is applied at this stage to enable liquefaction.
Cookers with a high temperature stage (120-150 degrees Celsius) and a lower temperature holding period (95 degrees Celsius) are used.
Saccharification The mash from the cookers is cooled and the secondary enzyme (glucoamylase) is added to convert the liquefied starch to fermentable sugars (dextrose).
Fermentation Yeast cells are added to the mash to ferment the sugars to ethanol and carbon dioxide in either a continuous process or a batch process, which takes about 48 hours. The fermented mash, now called beer, contains about 10% alcohol plus all the non-fermentable solids from the corn and yeast cells.

The beer is now ready to separate ethanol by distillation. The mash is pumped to the continuous flow, multi-column distillation system where the ethanol is removed from the solids and the water by evaporation. The ethanol leaves the top of the final column at 95-96% strength (190-192 proof). The residue mash, called stillage, is transferred from the base of the column to the co-product processing area

The ethanol from the top of the column passes through a dehydration system where the remaining water is removed as required for gasoline additives. Most ethanol plants use a molecular sieve to remove the remaining 4-5% water in the ethanol. The alcohol product at this stage is called anhydrous ethanol (pure, without water) and is approximately 200 proof. Denaturants such as gasoline are added subsequently to fuel ethanol to make the product undrinkable.

The fermentation process is conducted under anaerobic conditions and produces many substances in a reduced chemical state. Subsequent conditions are not conducive to their oxidation. All volatile substances are evaporated during the distillation and condensed with the ethanol. The distillate contains a variety of organic substances albeit in small concentrations. These are of no concern in fuel applications, but would affect the use of the ethanol for other purposes such as in pharmaceuticals or beverages.

The invention relates to the purification of a commercially produced ethanol or alcohol using ozonation to oxidize the reduced state impurities. Ozone (O₃) is an allotropic form of oxygen. It is an unstable blue gas with a pungent odor, a molecular weight of 48 g/mol and a density as a gas of 2.154 g/liter at 0° and 1 atmosphere. It is approximately 13 times more soluble in water than is oxygen. Ozone is highly unstable and is a powerful oxidizing agent. It is non-persistent and has a very short half-life.

Typically, ozone is produced by passing oxygen, in some concentration, through a highly charged corona field, a technique known as “corona discharge” ozone generation. The corona may be produced by applying a very high electric potential (up to 20 kV) between two conductors that are separated by an insulating dielectric layer and a small gap. Under these conditions, molecular oxygen (O₂) passing through the gap between the conductors experiences sufficient dissociation energy due to an electron bombardment to partially dissociate. A certain fraction of the free oxygen radicals will associate with oxygen molecules to form O₃, according to the reaction equation:

3O₂+69 kcal⇄2O₃ (I)

The generation of ozone as represented by equation (I), is an equilibrium reaction. The reaction is endothermic to produce O₃, requiring energy, and is exothermic to produce O₂, giving up energy. Because of its equilibrium nature, actual conversion to ozone is relatively low, in the range of 2-14%, depending on the oxygen content of feed gas, the temperature of the reaction and properties of the ozone generator.

In an embodiment, the invention converts or removes impurities from ethanol by oxidizing with ozone and adsorption on granular activated carbon (GAC). In an embodiment the invention relates to a process for treating a distilled ethanol with ozone and adsorption, preferably with granular activated carbon to remove impurities in minutes to produce a higher quality pharmaceutical or beverage alcohol.

Ozonation has “generally regarded as safe” (GRAS) status and may be used in food processing. GRAS status is established by the Food and Drug Administration (See Federal Register Citation 66 FR 33829, docket number 00F-1482, Jun. 26, 2001, Final rule: Electric Power Research Institute, Agriculture and Food Technology Alliance, Ozone in gaseous and aqueous phase as an antimicrobial agent on food, including meat and poultry, 21 CFR 173.368).

Features of the invention will become apparent from the drawings and following detailed discussion, which by way of example without limitation describe preferred embodiments of the invention.

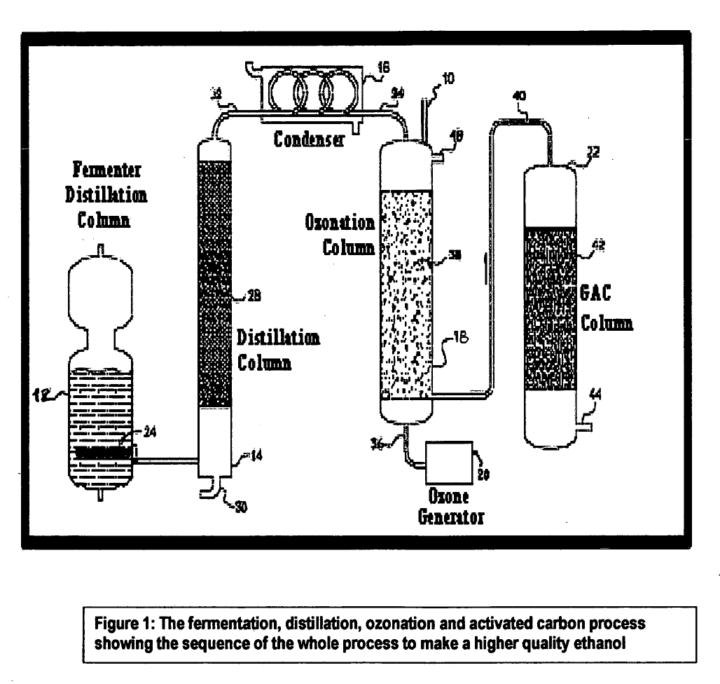

FIG. 1 schematically shows a system 10 to produce an upgraded distilled spirit from a grain mash. The system 10 includes cooker 12 to distill a fermented grain mash, distillation column 14, cooler 16, gas/liquid contact tower 18, ozone generator 20, and filtration column 22. In one process of the invention, ingredients are mixed to form a mash of grain, for example of course ground corn; sugar, yeast and water. The mash ferments at an elevated temperature, for example 90 to 95° F. for a period of 1-3 days. In this period, yeasts converts sugar to ethanol. The mash can be strained and heated by coils 24 in cooker 12 to boiling at a temperature 192 to 196° F. Cooking produces a vapor substantially of water and ethanol that passes through overhead conduit 26 that leads to distillation column 14. The distillation column 14 includes packing 28 to collect entrained liquid from the vapor. Collected liquid exits the column 14 at a bottom conduit 30.

The temperature at the top of the column 14 can be maintained between about 172 to 176° F. so that water vapor condenses and eventually passes down to and exits via the bottom conduit 30. An ethanol rich steam passes from the top of the column 14 via conduit 32 to a cooler 16, where it is condensed into an ethanol-rich liquid. The liquid is fed 34 to the top of gas/liquid contact tower 18. The contact tower 18 can contain a contact medium to promote contact between liquid and gas.

Ozone generator 20 is shown connected by ozone feed line 36 to a lower part of the contact tower 18. The ozone generator 20 can be a typical commercial ozone generator that applies a high-voltage charge to an air or oxygen feed to convert a portion of the feed to ozone-rich discharge gas. For example, the generator 20 can be a corona discharge ozone generator that uses either a desiccated air feed or pure oxygen feed. The ozone air/oxygen mixture can be reacted with the liquid in a batch arrangement or in continuous flow as illustrated in FIG. 1. Ducting for the ozonated gas into the liquid contact vessel can be of an ozone resistant material to avoid deterioration of both the material and the liquor. Examples of such materials are glass, stainless steel of suitable grade (304 or 316), aluminum, Teflon®, Viton® and ceramic materials.

In a batch arrangement, a quantity of liquid is placed in a container or vat and an ozone gas mixture is dispersed through the liquid using porous diffusers at the end of a gas line. Porous diffusers can be submerged in liquid to a depth for example of at least 6 inches and up to 20 feet. The gas mixture is introduced gradually over a period of at least 10 minutes for lower ozone dosages and longer for higher dosages.

Continuous ozonation as shown in FIG. 1 can be effected by pumping the liquid into the contact tower 18 at a rate matching a rate of ozone/gas mixture inflow. The rates are adjusted to provide a target level of ozone introduction and contact with the liquid. An arrangement of porous diffusers in the contact tower 18 can be similar to that described for batch equipment.

In the FIG. 1 embodiment, ozone rich gas from generator 20 is fed via line 36 to the contact tower 18 through porous diffusers to rise upward through the ethanol in tower 18 countercurrent to the downward flowing ethanol rich liquid. After ozone has dissolved into the liquor, the remaining air or oxygen is discharged at 48.

In an alternative ozone contact method, solid packing material 38, consisting of loose objects with large void spaces, such as ceramic rings, saddles or other irregularly shaped objects is placed in contact tower 18. The ethanol is pumped on to the top of this packing material and allowed to run through the packing material to flow as a film over the individual objects. Ozonated gas is still fed to the column from below. The countercurrent flow and the contact medium 38 within the tower effect an intimate contact between the ethanol rich liquid and gas to effectively ozonate the liquid. The packing material ensures a large contact area between the ethanol and the ozonated gas for good ozone transfer to the ethanol.

In an alternative ozone contact method, perforated plates or trays could be placed horizontally on top of each other in contact tower 18. Space is left between such plates. The ethanol will flow downwards through the holes in the plates, while the ozonated gas flows upwards through the holes. Contact between the gas and liquid phases is enhanced through these holes.

In an alternative contact method, the ethanol is sprayed into contact tower 18 through nozzles. The ethanol will then fall as droplets through the ozonated gas. The ozone encounters a large surface area of droplets for ozone transfer.

In an alternative contact method, the liquid is pumped in a line through a venturi or eductor or injector. The venturi or eductor or injector serves to suck ozone gas into the liquid line to mix the gas with the liquid. The resulting liquor/gas mixture can continue to flow within the line with or without a static mixer that can serve to ensure gas/liquid contact. Then, the gas-liquid mixture is conveyed within the line into a separation vessel to provide an opportunity for the inert gases (air or oxygen) to escape.

Ozone dosage is a function of impurities to be removed. Dosages of ozone between 5 mg/L to 1000 mg/L (ozone to liquid) can be effective. However, in some applications, a dosage of more than 30 mg/L is undesirable as producing a medicinal taste. The dosage can be linked and determined by GC/MS headspace analyses of volatiles. The analysis can identify unwanted compounds to control ozone dosage.

In the FIG. 1 method, ozone treated liquid passes from tower 18 via line 40 to the top of filtration column 22. In this example, the filtration column 22 is filled with GAC 42. The ozone treated liquid percolates through the column 22 to remove ozone oxidation byproduct impurities. The treated liquid emerges 44 from the column 22 as an upgraded alcohol product such as an upgraded distilled spirit similar to neutral grain spirit or an upgraded alcohol beverage or industrial ethanol. In a preferred embodiment, the system produces a neutral grain spirit, which is upgraded in aroma, taste and character.

The following EXAMPLE is illustrative and should not be construed as a limitation on the scope of the claims unless a limitation is specifically recited. The EXAMPLE represents work conducted at Iowa State University with the Atmospheric Air Quality Laboratory at this university conducting the analyses.

EXAMPLE A system including a gas/liquid vessel, ozone generator and adsorption vessel was built on laboratory scale and was used to ozonate and to subject samples to adsorption. In the procedure, ozone was generated from a commercial ozone generator (OZX-300U, Enaly Corporation, Shanghai) of 20 to 300 mg/h ozone production capacity, an internal air pump and an external air desiccator. Ozone production was measured using the iodometric method published in Standard Methods for Examination of Water and Wastewater by the American Public Health Association, American Water Works Association and Water Environment Federation, 20^{th} Ed., 1999.

Ozone dosages ranging from 20 to 80 mg/L were applied to an ethanol sample from a corn dry milling facility, containing 95% ethanol. No ozone emerged from the ethanol as it was all consumed in reactions in the ethanol. Some of the ozonated ethanol samples were transferred to a vessel containing granular activated carbon (Filtrasorb® 300, Calgon Corporation, Pittsburgh) and retained there for 5 minutes. The liquor was then filtered through a 100 μm screen to remove any activated carbon granules.

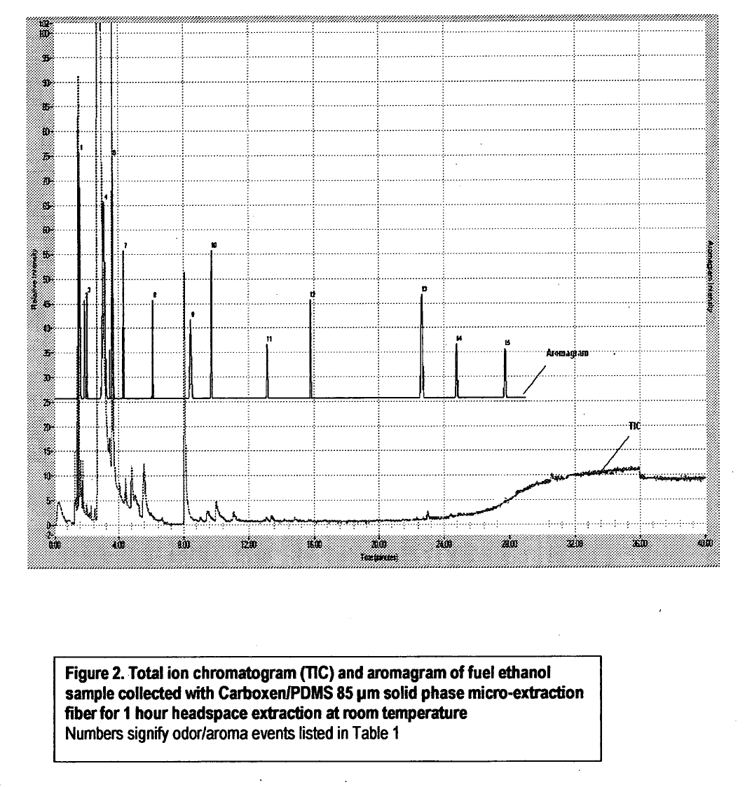

Ethanol without additional treatment was analyzed firstly by adsorbing vapors from the headspace above a sample on a resin at room temperature for 1 hour, a technique known as solid phase micro-extraction (SPME). The adsorbed vapor was then released into a gas chromatograph coupled with mass spectrometry, which also featured a port for olfactory appreciation. The results of these studies are depicted in FIG. 2.

FIG. 2. Total ion chromatogram (TIC) and aromagram of raw ethanol sample collected using Carboxen/PDMS 85 μm SPME fiber for 1-hour headspace SPME extraction at room temperature. Numbers signify odor/aroma events (Table 1).

As expected, much of the impurities are oxidized to acetic acid. Acetic acid is removed by adsorption on granular activated carbon.

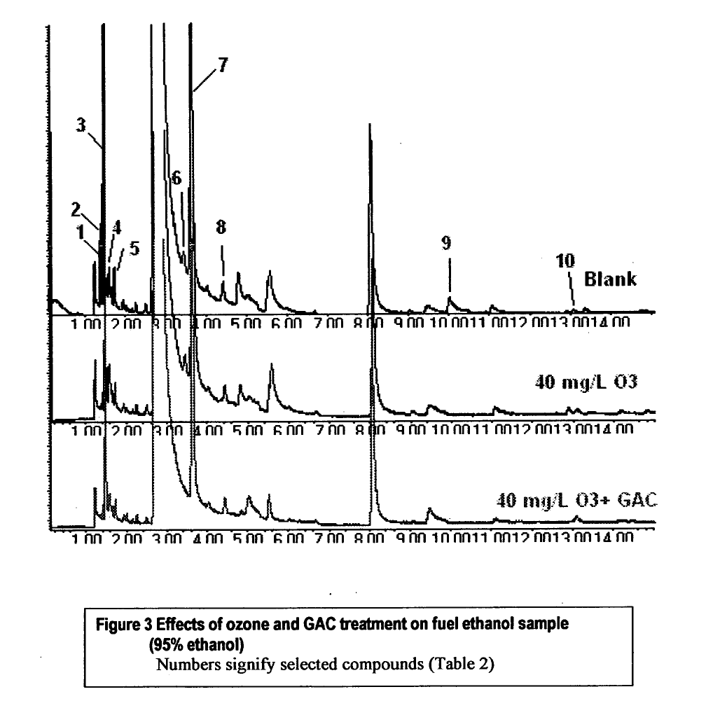

The effect of ozonation at 40 mg/L and of ozonation at 40 mg/L followed by GAC adsorption on ethanol quality as measured by the same methodology as above are shown in FIG. 3.

FIG. 3 Effects of ozone and GAC treatment on industrial ethanol sample. (Numbers signify selected compounds in Table 2)

Oxidation by ozone results in a decrease in number and concentration of reduced substances. As expected, the permanganate time of samples after ozonation increases. GAC adsorption also increases permanganate time.

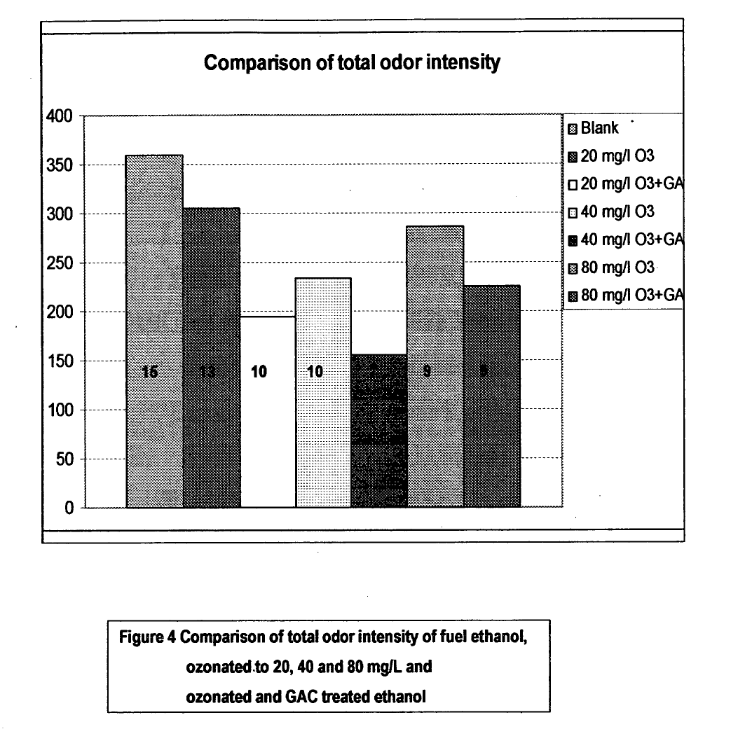

The odor intensity of the various components encountered in an untreated ethanol sample and in samples that have been ozonated to 20, 40 and 80 mg/L and samples ozonated to the same levels and also contacted with granular activated carbon were determined be separating the components as described above and by smelling the individual components. These results are shown in FIG. 4.

FIG. 4 Comprarison of total odor intensity of raw ethanol, ozone and GAC treated ethanol

A number of identified odors and their intensities (0 to 100% scale) and the effect of ozonation and GAC on their removal are listed in Table 1. Both treatments removed some undesirable odors from fuel ethanol, e.g., #10 burnt/burnt plastic, #13 smoky/medicinal. Both treatments produced a new “winey/sweet” note. The GAC treatment removed the offensive “skunky/rancid” note. Thus, both treatments have a great potential in aroma quality enhancement of liquor based on fuel ethanol.

Table 2 shows the removal of 10 selected components and their Chemical Abstract Service (CAS) ID number (identified with pure standard and matches with MS spectral libraries) and odor/aroma intensity removal from fuel ethanol by ozonation and GAC. All the information was obtained using SPME and analyses on GC-MS-O system. Both treatments show a great potential for significantly removing (up to 100%) some potentially/known toxic chemicals carried over from fuel ethanol, e.g., acetaldehyde, hexane, benzene, and styrene.

TABLE 1
Comparison of aroma events of fuel ethanol, 40 mg/l O₃ and 40 mg/l O₃ + GAC treated samples

| Raw ethanol | | | 40 mg/l O₃ treated ethanol | | | 40 mg/l O₃ + GAC treated ethanol | | |
|---|---|---|---|---|---|---|---|---|
| | | Intensity | | | Intensity | | | Intensity |
| Event # | Descriptor | (%) | Event # | Descriptor | (%) | Event # | Descriptor | (%) |
| 1 | Acetaldehyde | 50 | 1 | Acetaldehyde | 41 | 1 | Acetaldehyde | 31 |
| 2 | Winey | 20 | | | | | | |
| 3 | Aldehydic | 21 | 2 | Winey | 11 | 2 | Aldehydic | 6 |
| 4 | Winey | 40 | 3 | Aldehydic | 10 | | | |
| | | | 4 | Winey, Sweet | 40 | 3 | Winey | 40 |
| 5 | Earthy | 10 | | | | | | |
| 6 | Buttery, Winey | 49 | 5 | Buttery, Winey | 50 | 4 | Buttery, | 41 |
| | | | | | | | Winey | |
| 7 | Aldehydic | 30 | | | | 5 | Winey | 10 |
| 8 | Estery, Ketone | 20 | 6 | Winey | 11 | 6 | Winey | 8 |
| 9 | Winey | 16 | 7 | Winey | 20 | 7 | Winey | 20 |
| 10 | Burnt, Burnt plastic | 30 | | | | | | |
| | | | 8 | Skunky, Rancid | 30 | | | |
| 11 | Acidic | 11 | 9 | Acidic | 11 | | | |
| 12 | Winey, Estery | 20 | 10 | Winey, Sweet | 10 | | | |
| 13 | Smoky, Medicinal | 21 | | | | | | |
| 14 | Estery, Herbaceous | 11 | | | | | | |
| 15 | Vitamin, Medicinal | 10 | | | | | | |

TABLE 2
Reduction of 10 selected compounds and total odor/aroma intensity of different
dosage ozone and GAC treated raw ethanol. (“-” signifies generation)

| | | | | Reduction relative to “raw” fuel ethanol (%) | | | | | |
|---|---|---|---|---|---|---|---|---|---|
| | | | | 20 mg/L | 20 mg/L | 40\ | 40 mg/L | 80 mg/L | 80 mg/L |
| No. | RT | Compound name | CAS | O₃ | O₃ + GAC | mg/LO₃ | O₃ + GAC | O₃ | O₃ + GAC |
| 1 | 1.33 | 2-Methyl butane | 78-78-4 | 68 | 85 | 90 | 91 | 100 | 96 |
| 2 | 1.38 | Pentane | 109-66-0 | 47 | 79 | 85 | 86 | 95 | 94 |
| 3 | 1.45 | Acetaldehyde | 75-07-0 | 11 | 20 | 23 | 15 | 45 | 12 |
| 4 | 1.56 | 2-Methyl pentane | 107-83-5 | −11 | 46 | 47 | 57 | 45 | 74 |
| 5 | 1.63 | Hexane | 110-54-3 | −4 | 42 | 43 | 53 | 40 | 70 |
| 6 | 3.4 | Benzene | 71-43-2 | −101 | 99 | −9 | 97 | −105 | 94 |
| 7 | 3.58 | 1,1-Diethoxy ethane | 105-57-7 | −42 | 36 | −55 | 32 | −168 | 21 |
| 8 | 4.76 | 2-Butenal | 4170-30-3 | −8 | 89 | 29 | 81 | 39 | 74 |
| 9 | 9.95 | Styrene | 100-42-5 | 100 | 100 | 100 | 100 | 100 | 100 |
| 10 | 12.8 | Acetic acid | 64-19-7 | −117 | 96 | −297 | 37 | −592 | −242 |
| | | Total odor intensity | | 15 | 46 | 35 | 57 | 20 | 37 |
| | | Total odor events | | 13 | 33 | 33 | 53 | 40 | 40 |

What is claimed is:

1. A method of treating a distilled ethanol or alcoholic spirit intended for making a fuel additive, comprising contacting the distilled spirit with ozone and recovering an ozonated distilled spirit product of improved quality, aroma, taste or character.

2. The method of claim 1, further comprising subjecting the ozonated distilled spirit to an adsorption process to remove additional impurities or ozonation byproducts.

3. The method of claim 1, comprising subjecting the ozonated distilled spirit to adsorption with granulated activated charcoal (GAC).

4. The method of claim 1, further comprising subjecting the ozonated distilled spirit to adsorption to remove impurities and subjecting the product to filtration to produce a distilled spirit product of improved purity, aroma, taste or character.

5. The method of claim 1, wherein the distilled spirit is a distillate from a grain fermentation process.

6. The method of claim 1, wherein the distilled spirit is fuel grade ethanol.

7. The method of claim 1, wherein the distilled spirit is a food-grade alcohol.

8. The method of claim 1, wherein the distilled spirit is an industrial alcohol.

9. The method of claim 1, wherein the distilled spirit is a pharmaceutical alcohol.

10. The method of claim 1, further comprising subjecting the ozonated distilled spirit to adsorption wherein the distilled spirit includes undesirable organic compounds and potentially toxic compounds that are substantially removed by the ozonation and adsorption to improve purity, aroma, taste or character of the spirit.

11. The method of claim 1, further comprising subjecting the ozonated distilled spirit to adsorption wherein the distilled spirit includes a 2-methyl butane, pentane acetaldehyde, 2-methyl pentane, hexane, benzene, 1,1-diethoxy ethane, 2-butanal, styrene, and acetic acid, that are substantially converted or removed by the ozonation and adsorption to improve purity, aroma, taste or character of the spirit.

12. The method of claim 1, further comprising subjecting the ozonated distilled spirit to adsorption wherein the distilled spirit includes p-cresol, methyl mercaptan, and dimethyl trisulfide, which is substantially removed by the ozonation and adsorption to improve purity, aroma, taste or character of the spirit.

13. The method of claim 1, comprising distilling an alcoholic spirit from a grain or malt cooker, cooling the spirit to recover an ethanolic product, contacting this spirit with ozone and recovering an ozonated product of improved quality, aroma, taste or character.

14. The method of claim 1, comprising contacting the distilled spirit with a dosage of ozone of less than 1000 mg/L.

15. The method of claim 1, comprising contacting the distilled spirit with a dosage of ozone between 5 mg/L to 200 mg/L.

16. A method of processing an ethanolic stream, comprising continuously charging a condensed distilled fermentation product to the top of a processing column to flow downwardly through the column;
supplying ozone to the bottom of the processing column to flow countercurrently against and to intimately contact the downwardly flowing product to produce an ozonated product from the ethanol;
charging the ozonated product from the processing column to the top of an adsorption column; and
flowing the ozonated product downwardly through the adsorption column to recover an improved alcoholic product at the bottom of the adsorption column.

17. The method of claim 16, wherein the adsorption column comprises a column of granular activated carbon (GAC).

18. A system for processing an ethanolic product, comprising:
an ozone generator; and
a contact tower with a lower continuous ozone contacting gas feed from an ozone generator, an upper liquid ethanol or industrial alcohol feed and a recovery port to recover an ozonated ethanolic product.

19. The system of claim 18, further comprising an adsorption vessel connected to receive the alcoholic product from the contact tower recovery port and containing an adsorption medium.

20. The system of claim 18, further comprising a cooker to vaporize a spirit and a distillation tower to condense and purify the spirit to the liquid ethanol feed.
